(19) United States
(12) Patent Application Publication
(10) Pub. No.: US 2018/0033095 A1
(43) Pub. Date: Feb. 1, 2018

(54) METHODS AND SYSTEMS FOR CONNECTING USERS OF SOCIAL MEDIA NETWORKS THROUGH A NETWORK APPLICATION USING SHORT RANGE WIRELESS COMMUNICATIONS

(71) Applicant: Erich Atlas Ocean, Palmdale, CA (US)

(72) Inventor: Erich Atlas Ocean, Palmdale, CA (US)

(21) Appl. No.: 15/662,787

(22) Filed: Jul. 28, 2017

Related U.S. Application Data
(60) Provisional application No. 62/516,040, filed on Jun. 6, 2017.
(60) Provisional application No. 62/368,449, filed on Jul. 29, 2016.

(51) Int. Cl. G06Q 50/00; G06Q 30/02; H04L 29/08; G06F 17/30

(52) U.S. Cl. CPC G06Q 50/01; G06F 17/30029; G06Q 30/0201; H04L 67/10; H04L 61/1594

(57) ABSTRACT

Transforming short range wireless communications interactions into relevant links between nodes in a social graph or other database linking a person or object to other people, objects, locations, events, or content. The inferred links are based upon the proximity, frequency, duration, location, timing, degree, clustering, attributes, or assigned importance of the wireless communications interactions. The inferred links enhance the performance of social networking services where users have the existing wireless communications hardware, as being based upon meaningful and quality metrics.

### CROSS-REFERENCE TO RELATED APPLICATIONS

This application relates to and claims the benefit of U.S. Provisional Application No. 62/368,449, filed Jul. 29, 2016 and entitled FAST FOLLOWING, PASSIVE PROFILE CARD GATHERING, ACTIVE PROFILE CARD GATHERING AND PROFILE CARD PERMISSION LINKS FOR SOCIAL MEDIA NETWORKS, and of U.S. Provisional Application No. 62/516,040 filed Jun. 6, 2017 and entitled METHODS AND SYSTEMS FOR CONNECTING USERS OF SOCIAL MEDIA NETWORKS USING SHORT RANGE RADIO TECHNOLOGY, the entirety of the disclosure of each of which is wholly incorporated by reference herein.

### STATEMENT RE: FEDERALLY SPONSORED RESEARCH/DEVELOPMENT

Not Applicable

### BACKGROUND

### 1. Technical Field

The present disclosure relates generally to telecommunications systems and social media networks. More particularly, the present disclosure relates to methods and systems for connecting users of social media networks through a network application using short range wireless communications, and automatically inferring high-quality social graph links from interactions between a person or object and other people, objects, locations, events, or content.

### 2. Related Art

Social networking is one of the most popular uses of the Internet worldwide, and substantial improvements in mobile telephony communications networks have made connecting thereto possible from anywhere and at any time. According to recent surveys, active worldwide online social network accounts number over 2 billion. Furthermore, of the approximately 3.7 billion unique mobile users representing 51% of the world population, there are estimated to be 1.9 billion active mobile social network accounts. It is understood that mobile social network accounts have seen the most growth, as almost 2 million smartphones are sold every day and twelve new active mobile social network users are added every second one 1 million every day. Currently, over 73% of the population of the United States are estimated to have social network accounts. Because of this substantial user base, spending on advertising delivered through social networks have exceeded $23 billion worldwide.

As a general matter, a social network is a social structure made up of individuals connected by one or more specific types of interdependency such as friendship, common interests, and shared knowledge. Online social networking services extend the reach of social networks through defined connections that often reflect the real-life social networks among people. The services incorporate functionality that allows users to “connect” and share or “post” personal content such as photographs, videos, messages, activities, events, ideas, and interests with other users similarly connected to the service. Although users access the social networking service most commonly through web browser, applications that run natively on the mobile device that provide a similar interface to the web-based counterpart are also popular.

Presently there are hundreds, if not thousands, of online social network services. In its relatively short history, certain services have experienced more popularity and growth than others. Among the most dominant in terms of user base and activity include Facebook, Twitter, LinkedIn, Instagram, Snapchat, YouTube, and Google+.

The most important asset of a social network service is its social graph, which is a linked database representing its users and content as nodes, and the connections and activities between those nodes as links. Collectively, these nodes and links comprise the proprietary social networking data that represents the fundamental value of the service and the entity that owns it.

A high-quality social graph is that which the links between the nodes are highly relevant to the users. Historically, the links in high-quality social graphs are built manually by individual users who take specific actions on the social network service to create links to others. Although different services refer to this functionality using different terms, in general it involves the establishment of a link. For example, on Facebook, a user can “friend” other users, while on Twitter, a user may “follow” other users. On LinkedIn, this functionality is referred to as “connecting” with another user. Upon completion of the relevant linking action, which may also involve the receiving user acknowledging/approving the link request, a new link is established between the two nodes (users) in the social graph. Content that is posted by one user may then be shared with another user linked to the posting user. This content may be persistently associated with a profile of the user, as with biographical information and preferences such as hobbies, television shows, music, and movies. Alternatively, the content may be messages, status updates, and the like that are more ephemeral but nevertheless associated with the user. Furthermore, direct messages may be exchanged among and between users or multiple users.

The success and market value of a social networking service depends on a high quality social graph, and so much investments are made in the building and protection thereof. It is extremely important for new users to the social networking service to be immediately connected to the existing social graph, and that such connections are high quality links. Indeed, it is known that unless a new user establishes at least ten new links within the first two weeks of establishing an account, it is unlikely that such user will remain active, which is understood to be a key metric of success of a social networking service.

By comparison, a telephone directory such as the Whitepages, is an illustrative example of a social graph that is comprised exclusively of nodes without any links between the nodes. Although such directories may be useful when searching for a particular individual, this example illustrates the crucial importance of the links between nodes in a social graph. It is insufficient for a database to have numerous users; in the example of the Whitepages, at one point, almost the entirety of the adult population of the United States was listed therein. High-quality, relevant links between the users is understood to create social networking value. Thus, successfully enabling and encouraging users to create high-quality links in their proprietary social graph has separated successful social networking services from failures.

Improvements in mobility and positioning technology allow for the establishment of location-based social networking relationships that go beyond existing personal links. Nevertheless, challenges remain with respect to attracting new users to join a social networking service/social graph as a node, and then for such new users to establish connections/links to the existing users. Accordingly, there is a need in the art for creating high-quality, relevant links between nodes of a social graph.

### BRIEF SUMMARY

The present disclosure contemplates various systems and methods for inferring relevant links between nodes in a linked database with short range wireless communications. A temporary inferred link may be calculated between two nodes based on a single short range wireless interaction between the devices that are associated with the nodes. Furthermore, multiple short range wireless interactions over time, across multiple locations, multiple attributes, and multiple groupings may be processed to calculate a persistent inferred link between nodes in a social graph. Temporary and persistent links in the social graph may be combined, and the attributes thereof, together with user actions, may define the current relevance of one node to another. A social graph otherwise comprised only of nodes may be transformed into a high-quality social graph including relevant links between the nodes in accordance with various embodiments of the present disclosure.

As a general matter, the draw of social networking services is to stay connected with people within their personal and/or professional spheres, and to meet new people, either fortuitously as a consequence of shared interests and pursuits, or through referrals from trusted sources. The present disclosure contemplates the automatic inferring of relevant links between users without requiring the user to manually specify those social connections/links. Furthermore, the disclosure also contemplates the seamless establishment of these links on social networking services in the background while meeting other people in person, and suggesting relevant potential connections nearby based on similar interests and common connections.

One embodiment of the present disclosure is directed to a method for generating relational links among a plurality of nodes in a social graph database based upon interactions among proximally located wireless communications devices each corresponding to one of the plurality of nodes. The method may include receiving, an event record from a first wireless communications device associated with a first node. The event record may define an interaction between the first wireless communications device and a second wireless communications device associated with a second node as a set of one or more event attributes. The method may also include storing the event record in the social graph database as a temporary link. There may also be a step of generating a persistent relational link between the first node and the second node based at least in part upon the temporary link. Additionally, there may be a step of generating a relevancy score between the first node and the second node from an evaluation of the persistent relational link and the event attributes of the temporary link.

Another embodiment is directed to a method for establishing a link to one or more nodes from interactions with corresponding remote wireless communications devices. The method may include initiating interactions with the remote wireless communications devices over a wireless communications link. The method may also include a step of receiving interaction data generated by the remote wireless communications devices in response to the initiated interactions. There may be a step of generating event records at least partially based upon the received interaction data and local data. The event records may be defined by one or more event attributes. The method may also include synthesizing one or more temporary links to the one or more nodes in an ad hoc social graph data store from the generated event records. This method may be implemented as a series of instructions executable by a data processor and tangibly embodied in a program storage medium.

The present disclosure will be best understood by reference to the following detailed description when read in conjunction with the accompanying drawings.

### BRIEF DESCRIPTION OF THE DRAWINGS

These and other features and advantages of the various embodiments disclosed herein will be better understood with respect to the following description and drawings, in which like numbers refer to like parts throughout, and in which:

FIG. 1 is a diagram of an exemplary social graph in which users are represented as nodes and connections between the nodes correspond to manually created links between the users;

FIG. 2 is a diagram of another exemplary social graph depicting an event with attendees each associated with a wireless communications device, but otherwise lacking any connections between them;

FIG. 3 is a schematic diagram of an exemplary wireless communications device;

FIGS. 4A and 4B are screen shots of an example graphical user interface to a software application implementing various embodiments of the present disclosure;

FIG. 5 is a flowchart illustrating the steps of a method for establishing a link to one or more nodes from interactions with corresponding wireless communications devices;

FIG. 6 is a diagram of the social graph showing the interactions between proximal wireless communications devices;

FIG. 7 is a block diagram of the functional components of a system for inferring links with the wireless communications devices according to one embodiment of the present disclosure;

FIG. 8 is a diagram of an ad hoc social graph showing the temporary links generated from the interactions;

FIG. 9 is a flowchart illustrating the steps of a method for generating relational links among a plurality of nodes in a social graph database;

FIG. 10 is a diagram of the ad hoc social graph with temporary links combined with a persistent social graph containing the same nodes;

FIG. 11 is a diagram of the combined ad hoc and persistent social graph with numerical relevancy scores computed and assigned to each node;

FIG. 12 is an example database structure for event attributes stored on a remote server database;

FIG. 13 is a screen shot of an example graphical user interface to the software application implementing the embodiments of the present disclosure, with the relevancy computations limiting the number of individuals shown in the listing;

FIG. 14 is a diagram of the persistent social graph with a new persistent link added following the processing of historical interactions between nodes; and

FIG. 15 is a flowchart of another embodiment of the present disclosure.

### DETAILED DESCRIPTION

The detailed description set forth below in connection with the appended drawings is intended as a description of certain embodiments of methods and systems for connecting users of social networking services with short range wireless communication interactions. It is not intended to represent the only forms that the disclosure may be developed or utilized. The description sets forth the various functions in connection with the illustrated embodiments, but it is to be understood, however, that the same or equivalent functions may be accomplished by different embodiments that are also intended to be encompassed within the scope of the present disclosure. It is further understood that the use of relational terms such as first and second and the like are used solely to distinguish one entity from another without necessarily requiring or implying any actual such relationship or order between such entities.

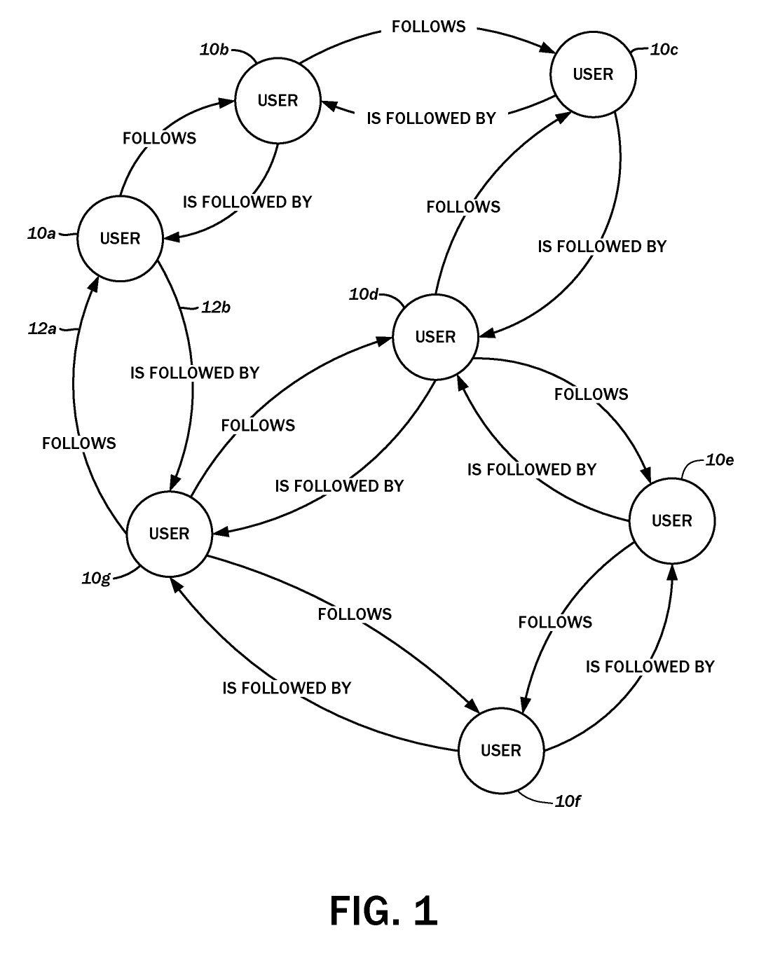

FIG. 1 depicts one exemplary social graph that represents the users and connections between the users of a social networking service that may be utilized in the context of the present disclosure. Specifically, each individual user having an account on the service is depicted as a node 10, with connections between each user being defined as both following links 12a and followed-by links 12b. In the illustrated example, there are seven users/nodes 10a-10g, with a first node 10a being connected to a second node 10b and a seventh node 10g, the second node 10b being additionally connected to a third node 10c, and the third node 10c being additionally connected to a fourth node 10d. The fourth node 10d may also be connected to the 7th node 10g as well as a fifth node 10e. The fifth node 10e may additionally be connected to a sixth node 10f, which in turn is also connected to the 7th node 10g. Although in the illustrated social graph, the source nodes and destination nodes are connected with by the following link 12a and the followed-by link 12b, respectively, this is by way of example only, as it is possible for some source nodes 10 to be connected by a following link 12a only without a reciprocal followed-by link 12b from the destination node 10.

Different social networking services refer to the links 12 by different names such as “friending” another user/node and so on, it is understood that, fundamentally, a linking relationship is being referenced. The social graph of FIG. 1 is a simplified visual representation of a typical social networking service that shows the logical relationships between nodes that are defined in a database. The implementation specifics of such a database and the way the nodes 10 and the links 12 are defined and referenced are understood to vary. Furthermore, there are substantially more users/nodes (numbering in the millions or more) and links between the nodes (couple hundred to more than a thousand each). To the extent the links 12 between the various nodes 10 exist or have been manually established by the users of the social networking service, individual nodes relative to a specific node can be ranked for relevancy, with such assigned relevancy scores being further serve as a basis to order, emphasize, suppress, or otherwise used for multiple use cases in the social networking service context. The present disclosure contemplates the use of these existing links 12, as well as generate new links where previously there were none, were incomplete, or lacked relevancy, based on physical proximity of suitable proxies for people, e.g., wireless communications devices such as smartphones.

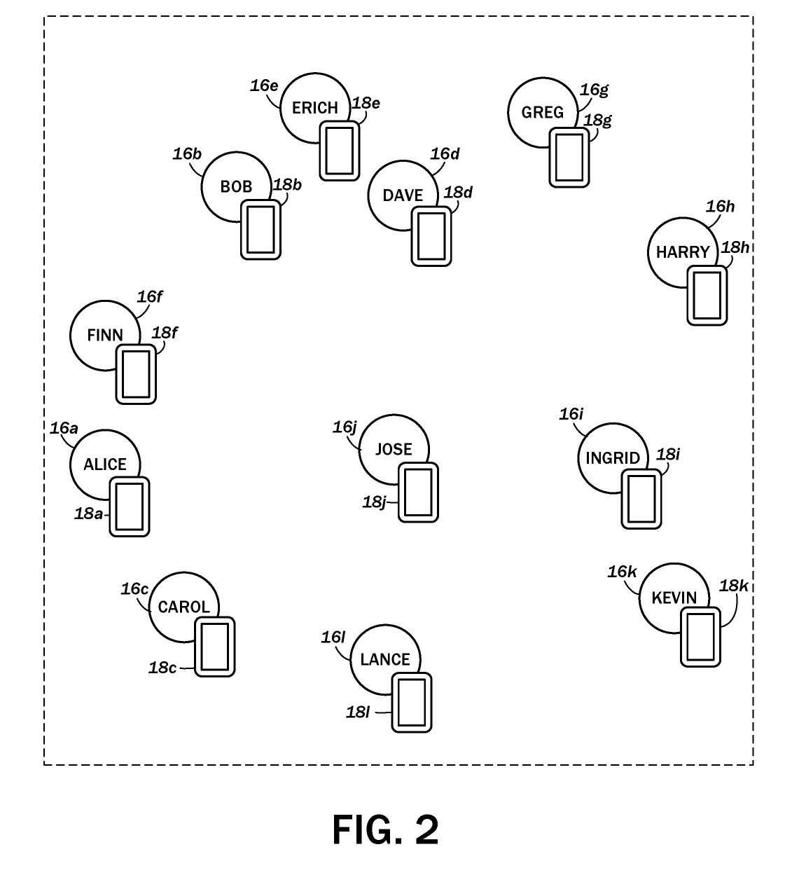

FIG. 2 depicts an exemplary physical space 14 in which a business networking event or other social gathering is taking place. Within this space 14 there are various individuals 16a-1, which may be entering and exiting the space 14 as the event continues. Each individual 16 is understood to be associated to a smartphone or other wireless communications device 18, since such devices are so widely used as to effectively serve as an electronic representation of the individual.

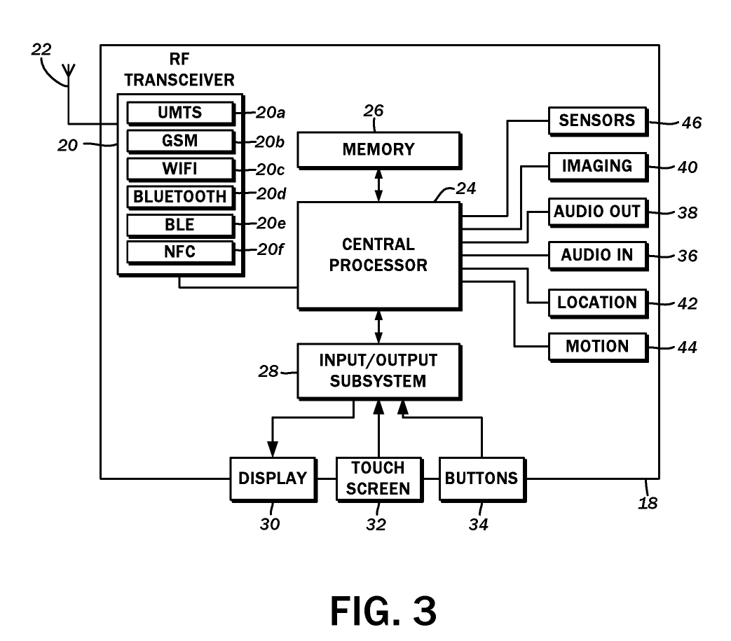

FIG. 3 illustrates one exemplary wireless communications device 18 on which various embodiments of the present disclosure may be implemented. As noted earlier, the wireless communications device 18 may be a smartphone, and therefore include a radio frequency (RF) transceiver 20 that transmits and receives signals via one or more antennas 22. Conventional devices are capable of handling multiple wireless communications modes simultaneously. These include several digital phone modalities such as UMTS (Universal Mobile Telecommunications System), 4G LTE (Long Term Evolution), and the like. For example, the RF transceiver 20 includes a UMTS module 20a. To the extent that coverage of such more advanced services may be limited, it may be possible to drop down to a different but related modality such as EDGE (Enhanced Data rates for GSM Evolution) or GSM (Global System for Mobile communications), with specific modules therefor also being incorporated in the RF transceiver 20, for example, GSM module 20b. Aside from multiple digital phone technologies, the RF transceiver 20 may implement other wireless communications modalities such as WiFi for local area networking and accessing the Internet by way of local area networks, and Bluetooth for linking peripheral devices such as headsets. Accordingly, the RF transceiver may include a WiFi module 20c and a Bluetooth module 20d. Standard Bluetooth connectivity involves handshaking and possibly pairing procedures that require manual user input to authorize the connection, but there are is an alternative Bluetooth-related, short-range wireless radio technology known as Bluetooth Low Energy (BLE). To this end, the RF transceiver 20 may include a BLE module 20e. Along the same lines, Near Field Communications (NFC) may also be implemented, in which case there may be an NFC module 20f. The enumeration of various wireless networking modules is not intended to be limiting, and others may be included without departing from the scope of the present disclosure.

The wireless communications device 18 is understood to implement a wide range of functionality through different software applications, which are colloquially known as “apps” in the mobile device context. The software applications are comprised of pre-programmed instructions that are executed by a central processor 24 and that may be stored on a memory 26. The results of these executed instructions may be output for viewing by a user, and the sequence/parameters of those instructions may be modified via inputs from the user. The central processor 24 thus interfaces with an input/output subsystem 28 that manages the output functionality of a display 30 and the input functionality of a touch screen 32 and one or more buttons 34. The software instructions comprising apps may be pre-stored locally on the wireless communications device 18, though web-based applications that are downloaded and executed concurrently are also contemplated.

The user primarily interacts with a graphical user interface that is generated on the display 30 and includes various user interface elements that can be activated based on haptic inputs received on the touch screen 32 at positions corresponding to the underlying displayed interface element. One of the buttons 34 may serve a general purpose escape function, while another may serve to power up or power down the wireless communications device 18. Additionally, there may be other buttons and switches for controlling volume, limiting haptic entry, and so forth. Those having ordinary skill in the art will recognize other possible input/output devices that could be integrated, and the purposes such devices would serve. Other smartphone devices may include keyboards (not shown) and other mechanical input devices.

The wireless communications device 18 includes several other peripheral devices. One of the more basic is an audio subsystem with an audio input 36 and an audio output 38 that allows the user to conduct voice telephone calls. The audio input 36 may be a microphone that converts sound to electrical signals, and may include amplifier and ADC (analog to digital converter) circuitry that transforms the continuous analog electrical signals to digital data. Furthermore, the audio output 38 may be a loudspeaker that converts electrical signals to air pressure waves that result in sound, and may likewise include amplifier and DAC (digital to analog converter) circuitry that transforms the digital sound data to a continuous analog electrical signal that drives the loudspeaker. It is possible to capture still images and video via an imaging module 40.

Due to its inherent mobility, users can access information and interact with the wireless communications device 18 practically anywhere. Additional context in this regard is discernible from inputs pertaining to location, movement, and physical and geographical orientation, which further enhance the user experience. Accordingly, the wireless communications device 18 includes a location module 42, which may be a Global Positioning System (GPS) receiver that generates coordinates data of the current location as extrapolated from signals received from the network of GPS satellites. Motions imparted upon the wireless communications device 18, as well as the physical and geographical orientation of the same, may be captured as data with a motion subsystem 44 that may include an accelerometer, a gyroscope, and/or a compass/magnetometer.

There are other sensors 46 that can be utilized in the wireless communications device 18 for different purposes. For example, one of the other sensors 46 may be a proximity sensor to detect the presence or absence of the user to invoke certain functions, while another may be a light sensor that adjusts the brightness of the display 30 according to ambient light conditions. Those having ordinary skill in the art will recognize that other sensors 46 beyond those considered herein are also possible.

Referring back to the social graph shown in FIG. 2, the event may require that its attendees register, and accordance with some embodiments of the present disclosure, each of the attendees may be provided with a list of all attendees for facilitating introductions and establishing in-person connections therewith. Such a list may be provided electronically to the attendees via e-mail, or via a software application running on the attendees' wireless communications devices 18.

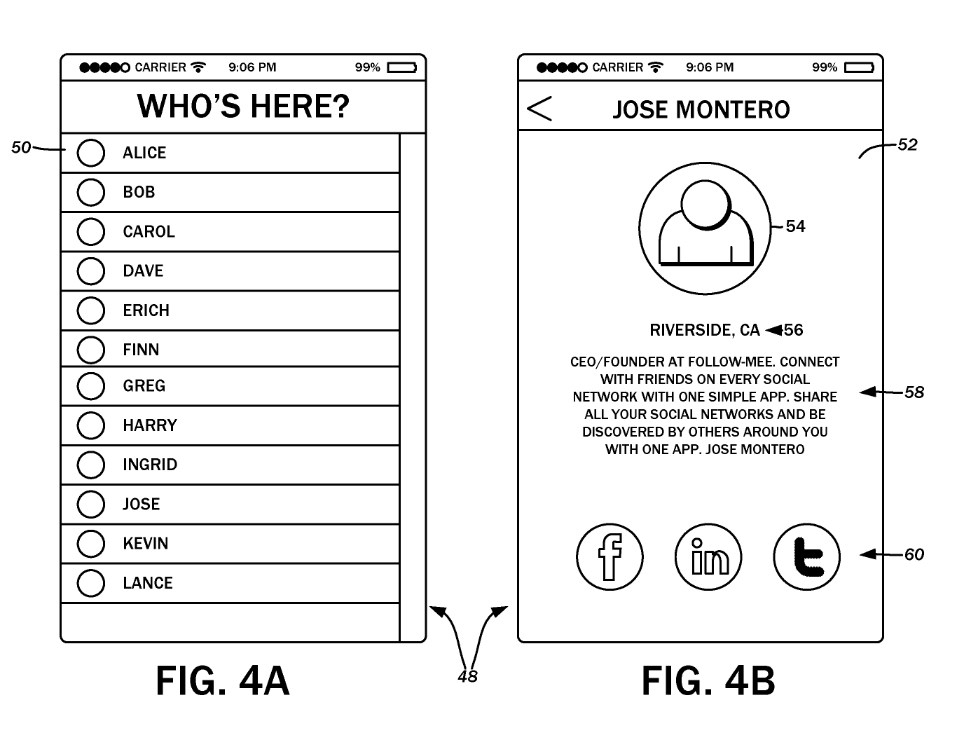

FIGS. 4A and 4B illustrate an example user interface 48 of such an app, with the screen capture of FIG. 4A showing a general listing 50 the registered attendees of the event, and the screen capture of FIG. 4B showing a detailed profile 52 of a particular attendee upon selecting the same from the general listing 50. The detailed profile 52 may include an avatar/profile picture 54, a location indicator 56, and a profile statement 58. The profile picture 54 is envisioned to assist with the identification of the attendee at the event. There may additionally be a listing 60 of social networking services of which the user is a member, designated by the icons thereof. These icons are understood to be user interface elements that, when activated, either a dedicated app for the selected social networking service is invoked and the content for the user is loaded therein, or a web browser application may be invoked with the specific URL of the selected social networking service and the profile page of the user is loaded. The specifics of the user interface 48 shown in FIGS. 4A and 4B are understood to be exemplary only and not of limitation, and any other design may be readily substituted without departing from the scope of the present disclosure.

This listing 50, however, may be inaccurate at best because attendees may be coming and going throughout the duration of the event. Furthermore, the listing itself may provide little context to the attendee viewing the same, and thus lacks relevance as there are no links between the nodes/attendees with which relevance can be computed, much as it is illustrated in the link-less social graph of FIG. 2.

The present disclosure contemplates the use of short range wireless communications modalities such as BLE and NFC implemented in the wireless communications devices 18 to identify the attendees at the event, and to synthesize temporary links between the attendees in an ad hoc social graph. This ad hoc social graph may be combined with a persistent social graph such as those of a conventional social networking service. A variety of insights may be gleaned from the combined data, particularly as it pertains to the relevancy of each attendee to other attendees at the event. Such relevancy determinations may be used, for example, to present the other attendees that may be of most interest. As will be described in further detail below, attributes of the interactions between the wireless communications devices over time may be recorded in a remote database, and the historical data may be utilized to infer new links in the persistent social graph of the existing social networking service in a separate process. Such links, in turn, are understood to further improve the accuracy of relevancy computations at future events and encounters.

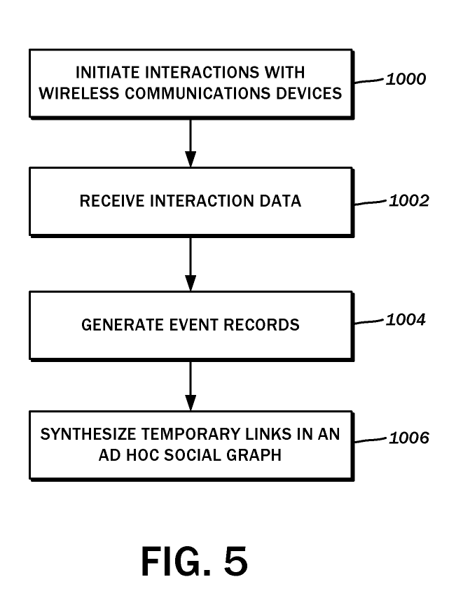

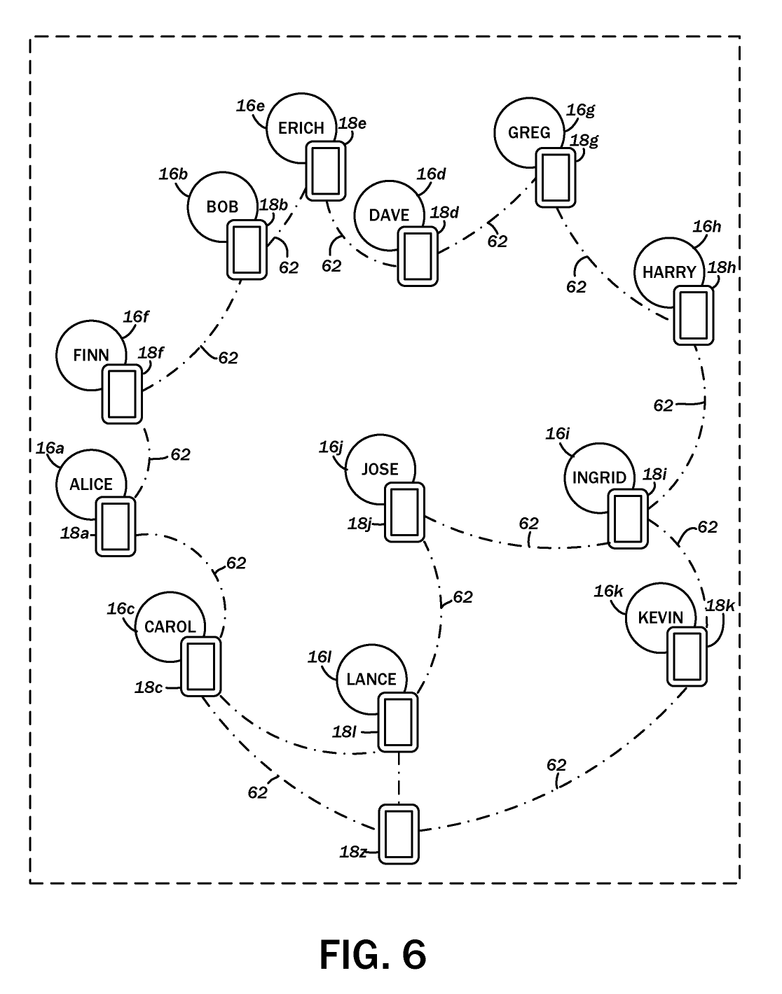

One embodiment of the present disclosure is a method for establishing a link to one or more nodes representing the individuals 16 with corresponding wireless communications devices 18, the steps of which are shown in the flowchart of FIG. 5. As indicated therein, the method may begin with initiating interactions with the remote wireless communications devices according to a step 1000. The social graph of FIG. 6, which is related to the previously discussed social graph of FIG. 2, illustrates the individuals 16 attending the event taking place in the physical space 14, with their respective wireless communications devices 18 carried thereby or otherwise proximal thereto. There may be additional wireless communications devices 18 such as an event-specific wireless communications device 18z. The wireless communications devices 18 initiate interactions 62 with each other passively, and without user interaction over a short-range wireless transmission protocol.

One preferred option for this protocol is the aforementioned Bluetooth Low Energy (BLE), though this is by way of example only and not of limitation. The interaction is understood to begin upon the wireless communications devices 18 coming within receptive range of the transmission, and thus occurs opportunistically. As a short range wireless technology, physical proximity between individuals may be assumed from the interactions between wireless communications devices 18 associated thereto, along with an inference that there is some logical link.

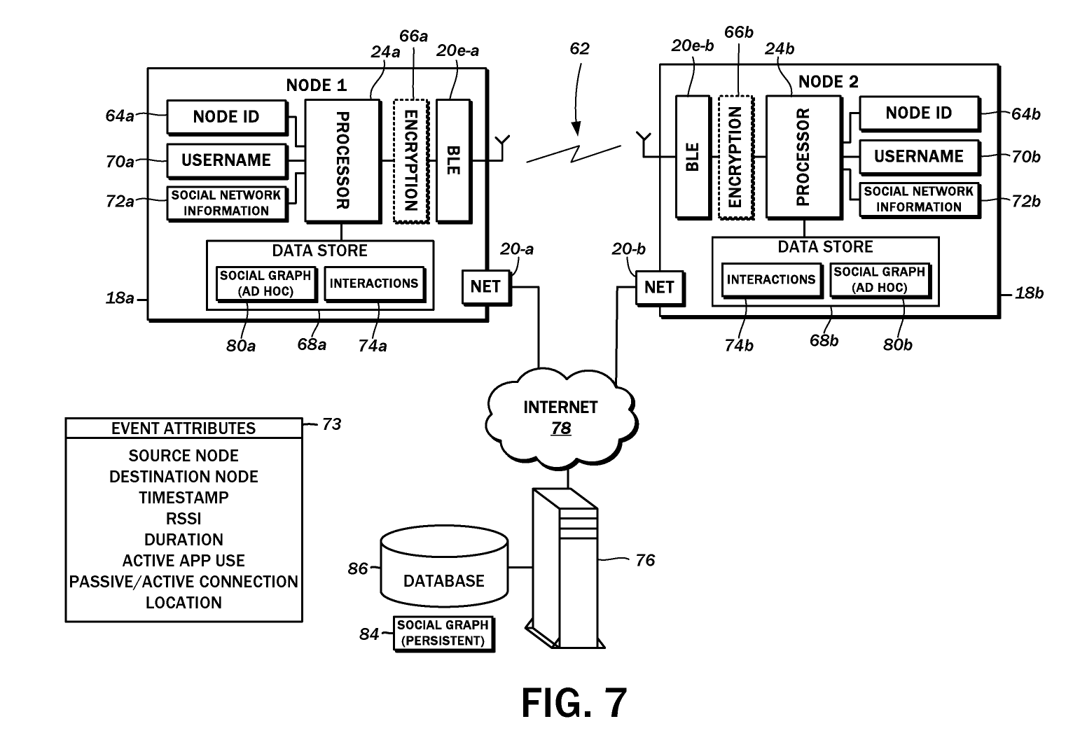

In further detail, the block diagram of FIG. 7 shows the pertinent components to the interaction 62 taking place between one wireless communications device 18 and another. There is a first wireless communications device 18a, designated as the origin node, and a second wireless communications device 18b, designated as the destination node. The origin node is understood to broadcast or advertise a unique node identifier 64a associated therewith, and is received by the destination node. The unique node identifier 64a is retrieved by the processor 24a, and passed to the BLE module 20e-a for wireless transmission. Optionally, the transmitted data may be encrypted, in which case the wireless communications device 18 may include an encryption module 66a. The destination node may likewise have an encryption module 66b that decrypts the encrypted and transmitted data in accordance with one embodiment of the present disclosure.

The counterpart BLE module 20e-b on the destination node receives the unique node identifier, and stores the same in a data store 68b for further processing. In addition to the unique node identifier, the origin node may also transmit information such as the username 70a of the individual 16 to which the wireless communications device 18a is associated, social network identities 72a, and the like. The unique node identifier, along with such information, is understood to be used for identifying interactions 62 as they occur, as well as load information about discovered nodes from an external source.

In response to the receipt of the node identifier 64a on the second node, the second node in turn may respond with a transmission of its own unique node identifier 64b. The same additional information regarding the destination node, e.g., the username 70b and the social network information 72b may likewise be retrieved and transmitted back to the origin node via the BLE module 20e-b. Information received by the destination from other nearby nodes, or otherwise derived or inferred therefrom may be incorporated into the transmission to the origin node. This interaction data 74b may be retrieved from the data store 68b, to which it was stored previously.

When the interaction proceeds to a part of the process in which data is being transmitted back to the origin node, BLE module 20e-a of the origin node reverses roles and becomes the receiver. Referring back to the flowchart of FIG. 5, the method continues with a step 1002 of receiving the interaction data. Thus, the individual nodes, and specifically the BLE modules 20e thereof, may interact with each other autonomously and automatically, without user confirmation or active knowledge that such interaction is occurring.

Continuing on with the method as taking place on the origin node, there is a step 1004 of generating event records based upon the received interaction data 74b from the destination node, as well as certain locally generated data. These event records are understood to be defined by one or more event attributes 73, which may include the aforementioned node identifier 64, username 70, and the social network information 72, from both the origin node and the destination node.

There are other event attributes 73 that may provide a further level of insight into the interaction 62, including those pertaining to the nature and duration thereof. Specifically, the detected radio power of the transmissions to and from the wireless communications device 18 may be recorded. According to one embodiment, this may be specified as an arbitrary figure referred to as a Received Signal Strength Indicator (RSSI). This is contemplated to be representative of the proximity of one wireless communications device to another. Another potential event attribute 73 is the number of interactions within a specific interval. Furthermore, various attributes associated with the RF transceivers of the wireless communications devices 18 may also be an event attribute 73. The time at which the interaction occurred 62 may be recorded as an event attribute 73, along with a flag or other indicator as to whether or not the user was actively using the software application when the interaction occurred, and whether or not the interaction was passive or was actively requested by the user. The location of the wireless communications device 18 may also be an event attribute 73.

These additional BLE interactions and their attributes are understood to enable a richer calculation of relevance. For example, if wireless communications devices 18 interact often, over a long period of time, over multiple intervals, or with high signal strength, inferences such that the corresponding individuals 16 of the nodes “know” each other, and a persistent link between them can be generated on a social graph. In comparison to existing social networking conventions that require users to “friend” each other, “follow” one another, or otherwise require some action on both individuals (the one initiating and the one responding), it is contemplated that persistent links may be inferred automatically without any active input from the users involved.

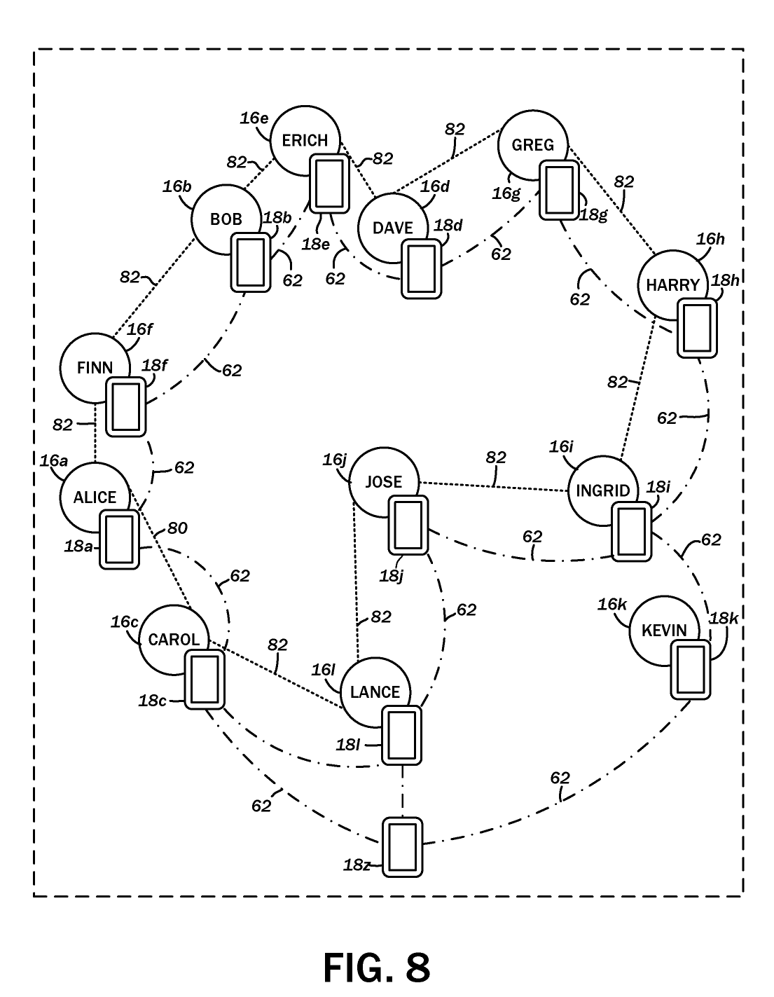

In a step 1006, one or more temporary links 82 to one or more nodes in an ad hoc social graph 80a are synthesized based upon the generated event records. The diagram of FIG. 8 is a representation of these temporary links 82 in the ad hoc social graph 80 that have been synthesized in accordance with the contemplated methodology of the present disclosure.

Power iteration is a known graph relevancy calculation that may be performed by processing and propagating relevancy information between a node and its immediate neighbors. Such computations and its immediate results may be shared during the interactions 62 without a central or overseeing server computer system. As will be described in further detail below, in accordance with various embodiments of the present disclosure, the data 74 pertaining to the interactions may be provided to a remote server 76 that may be accessible via the Internet 78. The wireless communications devices 18 include various communications modalities by which a connection to the Internet 78 may be established, so the details thereof will not be repeated here. To the extent a connection to the remote server 76 cannot be established, relevancy computations may nevertheless be made based upon the ad hoc social graph 80.

It is expressly contemplated that sharing the ad hoc social graph 80 and the data corresponding thereto as a whole over the interactions 62 is possible. Individual nodes can incrementally build a global view of the ad hoc social graph 80 locally, on which relevancy computations may be performed.

The ad hoc social graph 80 and the constituent temporary links 82 between nodes may be associated with a particular event by the presence of the event-specific wireless communications device 18z within communicable proximity to the other wireless communications devices 18 that are also intended to be part of the event. By way of transitive closure of the ad hoc social graph 80, all connected nodes are considered to be a part of the same event. Should there be no event association defined, by either the event-specific wireless communications device 18z or another wireless communications device 18 associated with an individual 16 attending the event and designated as such, the ad hoc social graph 80 created is understood to be anonymous. Alternatively, nodes may be registered directly with an event such as by entering a registration code, scanning a QR code, or the like. This involves user intervention, however, and an improved user experience is contemplated with the use of transitive closure of the ad hoc social graph 80.

The generated temporary links 82 may be removed in accordance with a predefined link removal policy. Unless so removed, the transitive closure of the ad hoc social graph 80 may eventually lead to all nodes, past and present, being encompassed. One contemplated link removal policy is determining the time period between the interactions 62, and if there have been no interactions 62 between a particular pair of nodes for the preceding fifteen minutes, then the temporary link 82 corresponding thereto is removed from the ad hoc social graph 80. If either or both of the subject nodes interacts with different nodes within a shorter time frame, removal may take place earlier. Those having ordinary skill in the art will be able to ascertain other link removal policies for specific circumstances.

Along these lines, managing the ad hoc social graph 80 may involve continuous analysis thereof to decide when to combine, split, and/or discard independent ad hoc social graphs 80 over time as the interactions 62 occur. Various policies may be adopted to facilitate management, and utilize standard graph analysis techniques as part of these policies, such as computing strongly connected components in order to determine when and how to break a single ad hoc social graph 80 into separate ones, or combining one ad hoc social graph 80 with another into a single, larger ad hoc social graph 80.

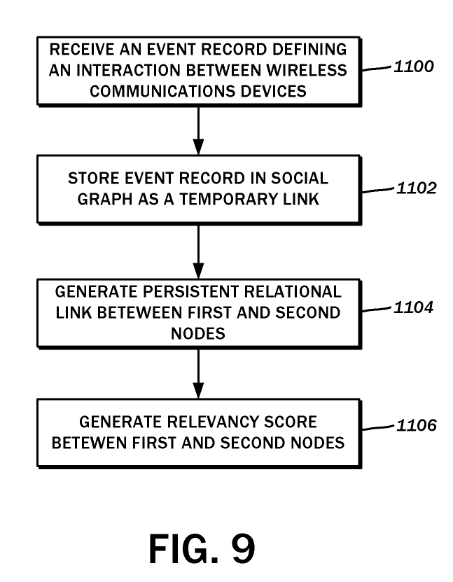

The present disclosure further contemplates a method for generating relational links among a plurality of nodes in a social graph database based upon interactions 62 among proximally located wireless communications devices 18. With reference to the block diagram of FIG. 7, the ad hoc social graph 80 from the wireless communications devices 18 are transferred to the remote server 76, and combined with a persistent social graph 84 that may be part of an existing social networking service and stored in a database 86 accessed by the remote server 76. Referring now to the flowchart of FIG. 9, the method begins with a step 1100 of receiving, from the first wireless communications device 18a associated with the first node, an event record. Again, the event record defines an interaction 62 between the first wireless communications device 18a and the second wireless communications device 18b associated with the second node, and may include data such as the node identifier 64, username 70, and social network information 72, as well as other information about the interaction 62. This step may be the culmination of the methodology discussed above with reference to the flowchart of FIG. 5, though this is by way of example only and not of limitation.

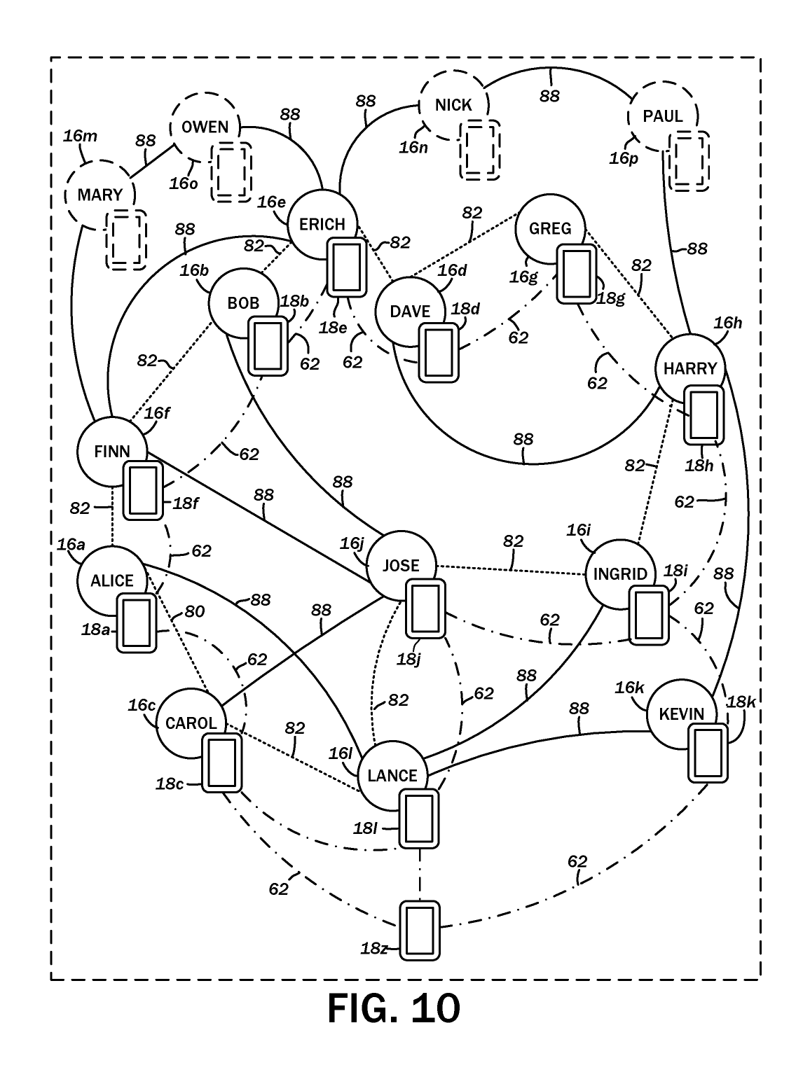

This event record may, in turn, stored as a temporary link 82 in a social graph according to a step 1102. This may be the ad hoc social graph 80 discussed previously. Referring to FIG. 10, the ad hoc social graph 80 for a single event or anonymous group may be combined with a larger, persistent social graph 84 with the same nodes. The persistent social graph 84 is understood to include persistent links 88 between certain nodes. There may also be nodes not present in the ad hoc social graph, including those corresponding to individuals 16m, 16n, 16o, and 16p. These are understood to be individuals 16 who were not present at the event, but are otherwise have connections with the attendees.

The persistent links 88 may be automatically inferred in accordance with various embodiments of the present disclosure, or they may originate from other sources such as previous interactions 62 and external database. Any of the foregoing ways in which a persistent link 88 is defined in the persistent social graph 84 is understood to corresponding to a step 1104 of generating a persistent relational link between the first and second nodes.

In one implementation, the ad hoc social graph 80 and the persistent social graph 84 are separated, with the method involving the combining of the two. An alternative implementation contemplates the insertion of the temporary links 82 into the persistent social graph 84, with such links being disambiguated with tags or other known modalities. Still further, the nodes and the temporary links 82 may be processed in accordance with the timestamps associated therewith, while logically constructing the ad hoc social graphs 80 on demand. Those having ordinary skill in the art will appreciate that any other implementation may be readily substituted. One contemplated utility of the ad hoc social graph 80 is to limit the results set of a query of the individuals 16 to those in the ad hoc social graph 80 while relevancy is evaluated on the larger, persistent social graph 84.

One embodiment of the present disclosure contemplates the automatic generation of persistent links in ad hoc social graphs 80, though it may draw upon existing persistent links in the persistent social graph 84 of the broader social networking service. These persistent links 88 may be based on established “follow,” “friend,” or “connect,” relationships that have been manually specified through a particular social networking service. In many cases, users have established accounts on multiple social networking services, and according to various embodiments of the present disclosure, the persistent links from each such social networking service may be combined with the ad hoc social graph 80 described above.

Manually specifying each of these separate links on different social networking services is understood to be a time-consuming and tedious process, and may be burdensome to both the origin node and the destination node. To this end, various embodiment of the present disclosure contemplate an automated “fast follow” procedure that deep links to each of the listed social networking services as shown in, for example, the interface of FIG. 4B. By invoking the fast follow function, the first social networking service listed, e.g., Facebook, is invoked, initiating the “friending” procedure on the dedicated Facebook app or web interface. An interface element may be overlaid that returns the interface to the application, and automatically, without user intervention, proceeds to the next social networking service, e.g., LinkedIn. This procedure may be repeated for the remaining listed social networking service, e.g., Twitter.

The detailed profile 52 is understood to be a representation of a “card” that may be distributed wirelessly similar to the aforementioned interactions 62 that are initiated by the wireless communications device 18. Depending on the permissions that are set for its distribution, other wireless communications devices 18 coming within receptive range of the broadcast transmission may retrieve the information set forth in the card, including the deep links to the social networking service profiles/accounts with which the persistent links 88 may be established.

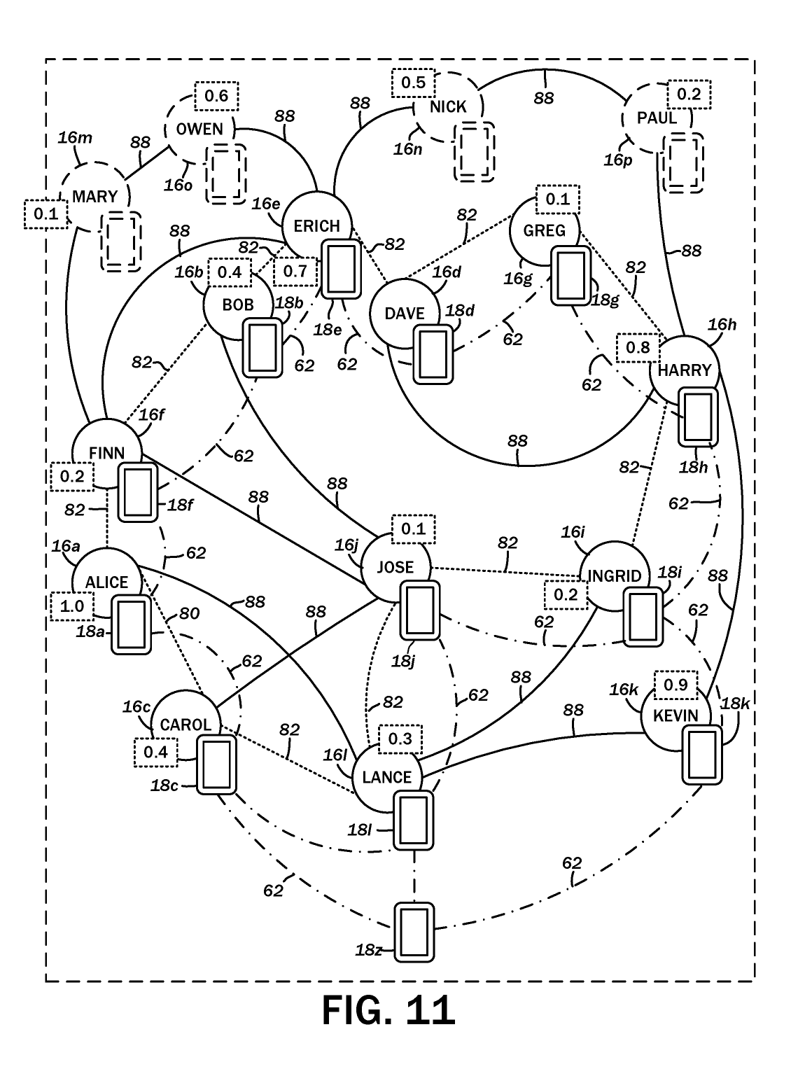

Returning to the flowchart of FIG. 9, the method continues with generating a relevancy score between the first node and the second node from an evaluation of the persistent link 88 and the event attributes of the interaction 62/temporary link 82. This step may be repeated for all of the other node pairs with the persistent links 88 in the persistent social graph 84. The social graph shown in FIG. 11 includes exemplary relevancy computations for each of the nodes corresponding to the individuals 16. Each node is assigned a rank based upon the structure of the graph, the attributes of the nodes, the attributes of the links 82, 88 and the history and timing of interactions 62 between the nodes. Again, it is noted that the nodes that were not part of the ad hoc social graph 80 may be used for relevancy processing and given a score, as shown.

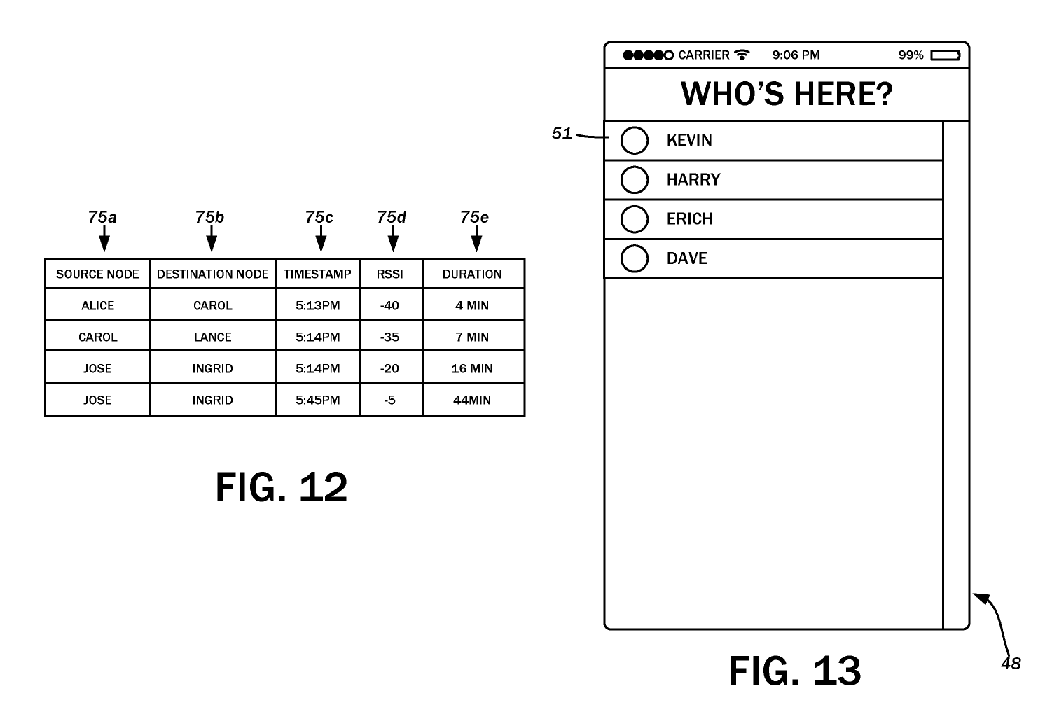

According to various embodiments, the event attributes 73 from each of the interactions 62, including the aforementioned source node identifier, destination node identifier, timestamp, RSSI, duration, active app use, passive/active connection, location, etc., may be transmitted to the remote server 76 for subsequent use. An exemplary form of the database for the event attributes is shown in FIG. 12, with a first column 75a for the source node, a second column 75b for the destination node, a third column 75c for the timestamp, a fourth column 75d for signal strength (RSSI) and the fifth column 75e for interaction duration. This database structure is presented by way of example only and not of limitation, and any other fields may be added, and any of the fields shown may be deleted, to the extent such deletion does not result in ambiguity.

It is understood that any relevancy computation algorithm or process may be utilized, and external data associated with the nodes and/or the links may be referenced as part of such process. Relevancy scoring may be performed separate for each individual 16 to provide personalized results on an individual-by-individual basis. Those having ordinary skill in the art will recognize that any other groupings for purposes of evaluating relevancy may be utilized, and there are numerous ways in which the relevancy data may be processed.

FIG. 13 is a screen shot of the user interface 48 to a software application that lists the attendees of the event as discussed above. However, in this embodiment, the number of entries listed is substantially reduced based on the assigned relevancy scores. Individuals 16d (Dave), 16e (Erich), 16h (Harry) and 16k (Kevin) are those with the highest relevancy scores to the viewing user, Individual 16a (Alice). The threshold may be set to, for example, 0.5, and only those exceeding this threshold is shown in the narrowed listing 51. Furthermore, the entries corresponding to the individuals 16 are ordered according to the relevancy scores, e.g., the node with the highest relevance corresponding to individual 16k is listed first, while the node with the lowest relevance corresponding to individual 16d is listed last. It will be appreciated that while the benefits of this filtering may not be immediately apparent for the relatively low number of individuals 16 within the social graphs 80, 84, when the number is increased to the thousands, the benefits will be clear.

In the example of FIGS. 11 and 13, although the relevancy scores for individual 16n and 16o are higher than the defined threshold, the entries are limited to those in attendance at the event. The nodes corresponding to these individuals are those that are part of the persistent social graph 84, but not part of the ad hoc social graph 80, and thus have been excluded from the narrowed listing 51.

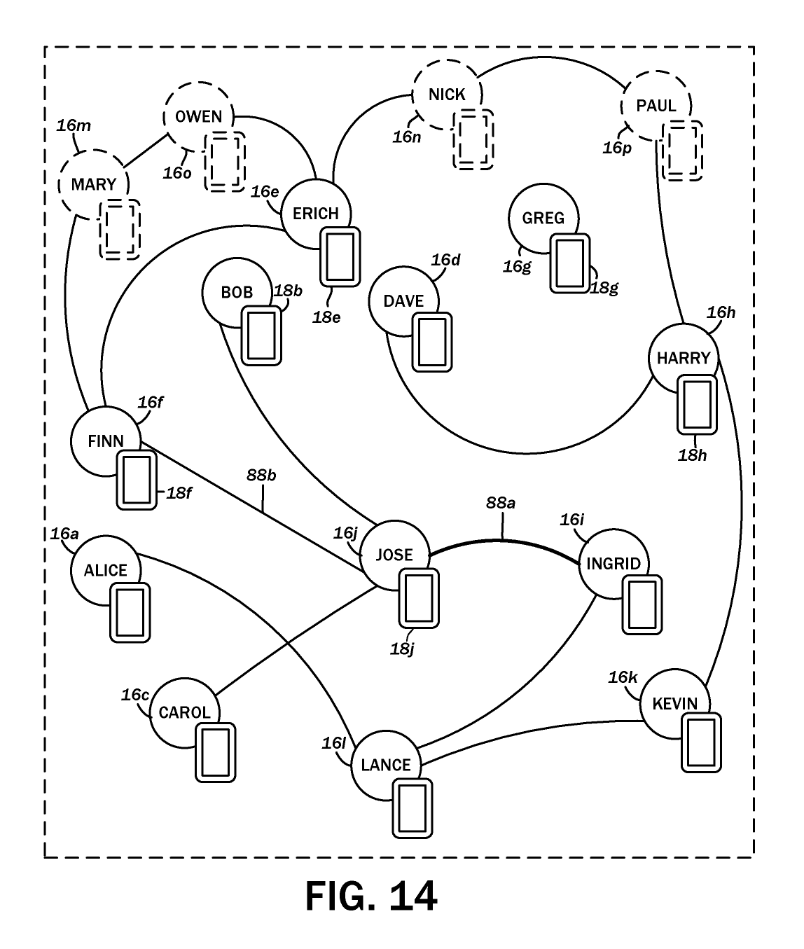

FIG. 14 illustrates the persistent social graph 84 after processing the history of the interactions, with a new persistent link 88a being generated between individual 16j (Jose) and 16i (Ingrid) based upon the amount of time spent together, and the strength of the received signal during the interaction. As another example, if two individuals 16 are near each other most days, and view each others' profiles regularly, there may be a high likelihood that the two are interested in each other, and a persistent link could be inferred. A variety of possible strategies are contemplated for determining that the history between two nodes or a group of nodes is relevant and a persistent link should be inferred. One such strategy is the use of relevancy processing modalities discussed above. It is to be understood, however, that such strategies are highly application-dependent, and the meaning of relevancy in each application context.

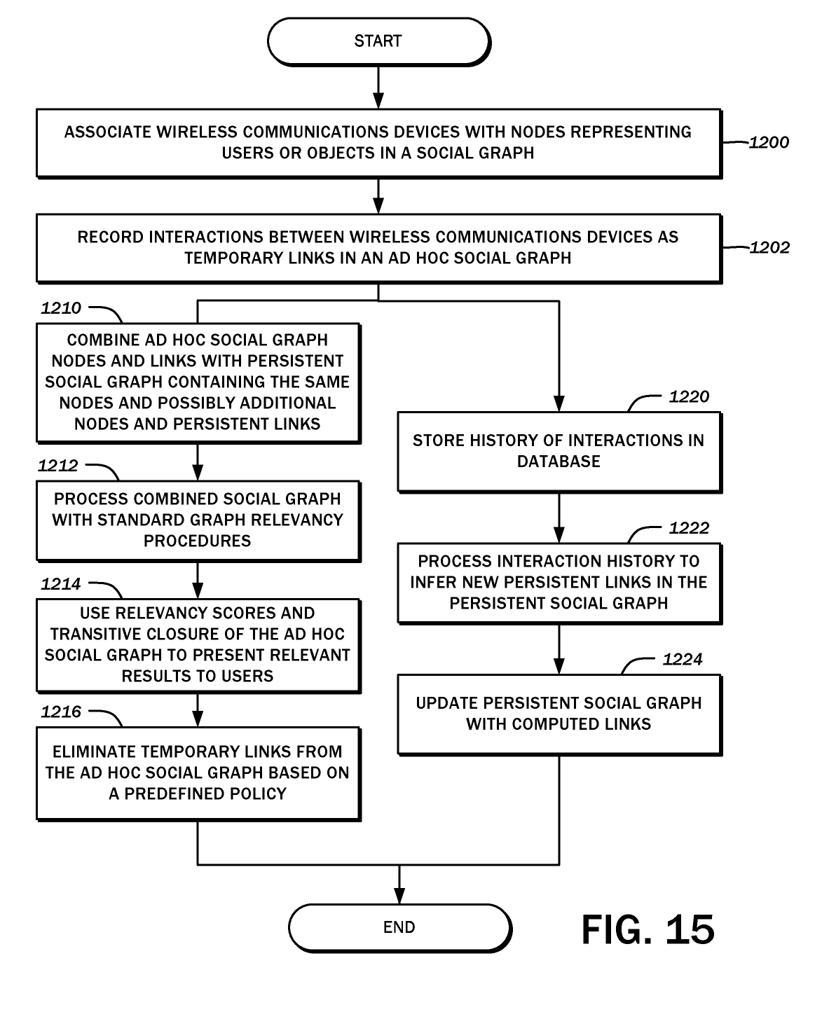

Another embodiment of the presently contemplated method is illustrated in the flowchart of FIG. 15, showing various steps thereof. There are two prefatory steps, including a step 1200 of associating the wireless communications devices 18 with nodes representing users or objects in a social graph, and a step 1202 of recording interactions 62 between wireless communications devices 18 as temporary links in an ad hoc social graph. These two steps have been discussed above in the context of the procedures shown in the flowcharts of FIGS. 5 and 9.

Thereafter, the procedure continues on one of two separate tracks, the first one beginning with a step 1210 of combining the ad hoc social graph 80 with the persistent social graph 84 that contains the same nodes as well as additional nodes and persistent links. This step is understood to correspond to the previously described steps 1102-1104 in the method described with reference to the flowchart of FIG. 9. There is also a step 1212 of processing the combined social graph with graph relevancy procedures, which results in the assignment of relevancy scores to each node. These relevancy scores, in conjunction with the transitive closure of the ad hoc social graph 80, are used to present relevant results to the users in accordance with a step 1214. As discussed earlier, there is a maintenance/housekeeping step 1216 of eliminating certain temporary links 82 from the ad hoc social graph 80 per a predefined policy.

The other track involves storing the history of the interactions 62 according to a step 1220, then processing that interaction history to infer new persistent links 88 in the persistent social graph 84 in a step 1222. This is understood to correspond to those portions of the method discussed above with reference to the flowchart of FIG. 9. These computed persistent links 88 are then updated on the persistent social graph 84 in accordance with a step 1224.

The particulars shown herein are by way of example only for purposes of illustrative discussion, and are presented in the cause of providing what is believed to be the most useful and readily understood description of the principles and conceptual aspects of the various embodiments set forth in the present disclosure. In this regard, no attempt is made to show any more detail than is necessary for a fundamental understanding of the different features of the various embodiments, the description taken with the drawings making apparent to those skilled in the art how these may be implemented in practice.

What is claimed is:

1. A method for generating relational links among a plurality of nodes in a social graph database based upon interactions among proximally located wireless communications devices each corresponding to one of the plurality of nodes, the method comprising:
receiving, from a first wireless communications device associated with a first node, an event record defining, as a set of one or more event attributes, an interaction between the first wireless communications device and a second wireless communications device associated with a second node;
storing the event record in the social graph database as a temporary link;
generating a persistent relational link between the first node and the second node based at least in part upon the temporary link; and
generating a relevancy score between the first node and the second node from an evaluation of the persistent relational link and the event attributes of the temporary link.

2. The method of claim 1, wherein the persistent relational link is further based at least in part upon one or more historical temporary links previously stored in the social graph database.

3. The method of claim 2, further comprising:
removing one or more historical temporary links previously stored in the social graph database based upon a predefined link removal policy.

4. The method of claim 1, further comprising:
generating another persistent relational link between the first node and a third node based upon existing data from the social graph database.

5. The method of claim 1, further comprising:
associating each of the proximally located wireless communications devices with an event based upon transitive closure of the temporary links stored in the social graph database.

6. The method of claim 1, wherein the one or more event attributes is selected from a group consisting of: identities of the first and second nodes, a duration of the interaction, a time stamp associated with the interaction, active/passive status of a user either or both of the first and second wireless communications devices, a geographic situs of the interaction, and a signal strength of a wireless link over which the interaction is carried.

7. The method of claim 1, wherein the first wireless communications device and the second wireless communications device interact passively without user intervention.

8. The method of claim 7, wherein the interaction begins upon the first wireless communications device being positioned within communicable range to the second wireless communications device.

9. The method of claim 7, wherein the first wireless communications device and the second wireless communications device establish a wireless link conforming to a predefined short-range wireless communications protocol.

10. The method of claim 1, further comprising:
receiving, on the social graph database, a query for one or more nodes meeting a predefined relevancy threshold to the first node; and
retrieving the one or more nodes responsive to the query.

11. A method for establishing a link to one or more nodes from interactions with corresponding remote wireless communications devices, the method comprising:
initiating interactions with the remote wireless communications devices over a wireless communications link;
receiving interaction data generated by the remote wireless communications devices in response to the initiated interactions;
generating event records at least partially based upon the received interaction data and local data, the event records being defined by one or more event attributes; and
synthesizing one or more temporary links to the one or more nodes in an ad hoc social graph data store from the generated event records.

12. The method of claim 11, further comprising:
transmitting the one or more temporary links to remote social graph database.

13. The method of claim 11, wherein the one or more event attributes is selected from a group consisting of: identities of the one or more nodes, a duration of the interactions, a time stamp associated with the interactions, active/passive status of a user of the remote wireless communications devices, a geographic situs of the interactions, and a signal strength of the wireless communications link over which the interactions are carried.

14. The method of claim 11, wherein initiating the interactions includes broadcasting a local node identifier.

15. The method of claim 14, wherein the interaction begins upon the remote wireless communications devices being within receptive range of the broadcasted local node identifier.

16. The method of claim 11, wherein the interaction is initiated passively without user intervention.

17. The method of claim 11, further comprising:
associating other proximally located remote wireless communications devices with an event based upon transitive closure of the temporary links.

18. The method of claim 11, further comprising:
receiving a user input corresponding to a registration for an event; and
associating the temporary links to other proximally located remote wireless communications with the event based upon the registration.

19. The method of claim 11, further comprising:
removing one or more temporary links previously stored in the ad hoc social graph data store based upon a predefined link removal policy.

20. An article of manufacture comprising a non-transitory program storage medium readable by a data processing apparatus, the medium tangibly embodying one or more programs of instructions executable by the data processing apparatus to perform a method for establishing a link to one or more nodes from interactions with corresponding remote wireless communications devices, the method comprising:
initiating interactions to the remote wireless communications devices over a wireless communications link;
receiving interaction data generated by the remote wireless communications devices in response to the initiated interactions;
generating event records at least partially based upon the received interaction data and local data, the event records being defined by one or more event attributes; and
synthesizing one or more temporary links to the one or more nodes in an ad hoc social graph data store from the generated event records.
